(19) United States
(12) Patent Application Publication
(10) Pub. No.: US 2013/0232016 A1
(43) Pub. Date: Sep. 5, 2013

(54) MULTI-VENDOR TICKET REDEMPTION SYSTEM

(71) Applicant: Stephen P. Shoemaker, JR., Redondo Beach, CA (US)

(72) Inventor: Stephen P. Shoemaker, JR., Redondo Beach, CA (US)

(21) Appl. No.: 13/410,765

(22) Filed: Mar. 2, 2012

(51) Int. Cl. G06Q 20/18

(52) U.S. Cl. 705/16

(57) ABSTRACT

A system for redemption ticket exchange with connected vending machines, comprising a selector designating a chosen vending machine from which to obtain an item, a ticket counter for receiving tickets and counting the tickets; a processor for keeping a count of the tickets, and generating a signal when the count reaches a predetermined number, a pulse generator for sending a pulse to the chosen vending machine when the count reaches a predetermined number, the pulse corresponding to an exchange value that can be used to redeem the item, and a printer for printing a receipt for tickets that do not total the predetermined number.

### BACKGROUND

In many arcades, bowling alleys, pizza parlors, amusement parks and the like, there are arcade games that provide entertainment to the patrons who come to such establishments. One type of arcade game distributes redemption tickets to the players based on the performance in the game. The redemption tickets can then be redeemed at the arcade at a stand or counter, where prizes are displayed. These prizes can be traded for the redemption tickets, where the value of the prize determines the number of tickets needed to trade for the item. The counter or display is usually manned by a clerk that counts the player's tickets and gives the prize to the player. The prize booth for popular arcades can require two or more clerks, costing the owner resources that could be spent elsewhere.

### SUMMARY OF THE INVENTION

The present invention is a ticket counter and redemption system that allows a player to select a prize, food item, drink item, or the like, and then feed tickets into the counter. The counter receives tickets and, when a unit of tickets is collected, sends a pulse to a vending machine that is translated into a unit of purchase. The system may include a rotary dial to select from various options such as a food vending machine, and prize vending machine, and a soda vending machine, or the like. The tickets can be collected in units of, for example, twenty-five (25) which can equate to a monetary value of fifty cents. Every twenty-five tickets collected, the system sends a pulse to the selected vending machine that can be credited against a purchase of an item. If the tickets do not total a “unit”, then the system prints out a receipt of the remaining tickets that can be credited on the next visit.

### BRIEF DESCRIPTION OF THE DRAWINGS

FIG. 1 is a schematic of a system of the present invention; and

FIG. 2 is a flow chart of the logic of the present system.

### DETAILED DESCRIPTION OF THE PREFERRED EMBODIMENTS

The present invention is a ticket redemption system that can be used in arcades, bowling alleys, pizza parlors, and other places where arcade type games are utilized and where the arcade type games generate redemption tickets. The ticket system includes a counting system, and a communication bus that connects to various vending machines that can hold and distribute either prizes, food, or drink. Such ticket counting systems are known, such as the present inventor's U.S. Pat. No. 6,796,487 entitled “Video Ticket Counter,” the contents of which are incorporated by reference herein. Such systems have a ticket port where players can feed the tickets into the housing of the ticket redemption center, where they are fed past a reading mechanism that reads either a bar code or a slot in the ticket, or otherwise counts each ticket that is fed into the ticket redemption center. Each ticket as it is read causes a signal to be sent to a processor, which keeps a running total of the player's tickets. The processor receives each signal, and tallies the ticket total until a preselected unit number is achieved. The unit number is a block of tickets that can be considered a purchasing block, such as twenty-five tickets or fifty tickets, established by the owner of the system. Once the unit number is reached, the microprocessor sends a pulse or signal to a connected vending selected by the player. The vending machine receives the pulse from the microprocessor, and attributes the pulse as a preselected monetary exchange, such as for example “fifty cents.” The player can add pulses by feeding more tickets into the system until a desired about of monetary exchange units has been accumulated to purchase a desired item.

Again, by way of example, say that the player wished to purchase a soft drink from a vending machine that is connected to the ticket redemption center. The soft drink costs two dollars, which is the equivalent of two hundred redemption tickets. The player, having accumulated two hundred tickets, first manually selects the soft drink vending machine from among the various connected vending machines using a rotary dial on the front of the ticket redemption center. Other types of selection mechanisms could be used instead of the rotary dial, such as selector buttons or the like. After selecting the desired vending machine, the player begins feeding the tickets into the ticket redemption center. The ticket counter counts the tickets as they are fed into the center and sends a signal to the microprocessor, which tallies the tickets. When a preselected unit value is reaches, such as twenty-five tickets, the microprocessor sends a pulse along a bus to the soft drink vending machine. The soft drink vending machine interprets the pulse as if twenty-five cents had been inserted into the coin slot. Each additional pulse credits the player with twenty-five more cents, until all the tickets are counted. At this point, eight pulses will have been sent to the soft drink vending machine, and two dollars will have been credited to the player. The player can then use the two dollars in credit to purchase the desired soft drink.

The ticket redemption center preferably includes a printer for printing a receipt for any surplus tickets that do not amount to a unit value. For example, if the player has 87 tickets in the example above, the redemption center would count tickets, sending a third pulse to the vending machine after the seventy-fifth ticket. After the next twelve tickets are read and counted, the ticket redemption center would have a display that queried the player if there was “any more tickets?.” If the player responded “yes,” the machine would wait for additional tickets to be inserted until a timed out period. If the player responds “no,” the microprocessor would receive the “no” response and cause the printer to print a receipt for twelve tickets, which could be redeemed at a later date. The ticket redemption center would have a reader that reads the receipts and immediately credits the player with the tally coded into the receipt. The receipt would preferably be a bar code or other machine readable language that could not be easily altered or adjusted by an unscrupulous player. The receipt would be taken by the player and used at a later date.

The same system can be used to purchase candy or toys or any vending machine items. More valuable prizes simply require more pulses, which can be achieved with more redemption tickets. In this manner, the whole ticket redemption process can be automated so that no clerk is needed, while simultaneously offering the player more options such as food and drink in addition to toys and prizes.

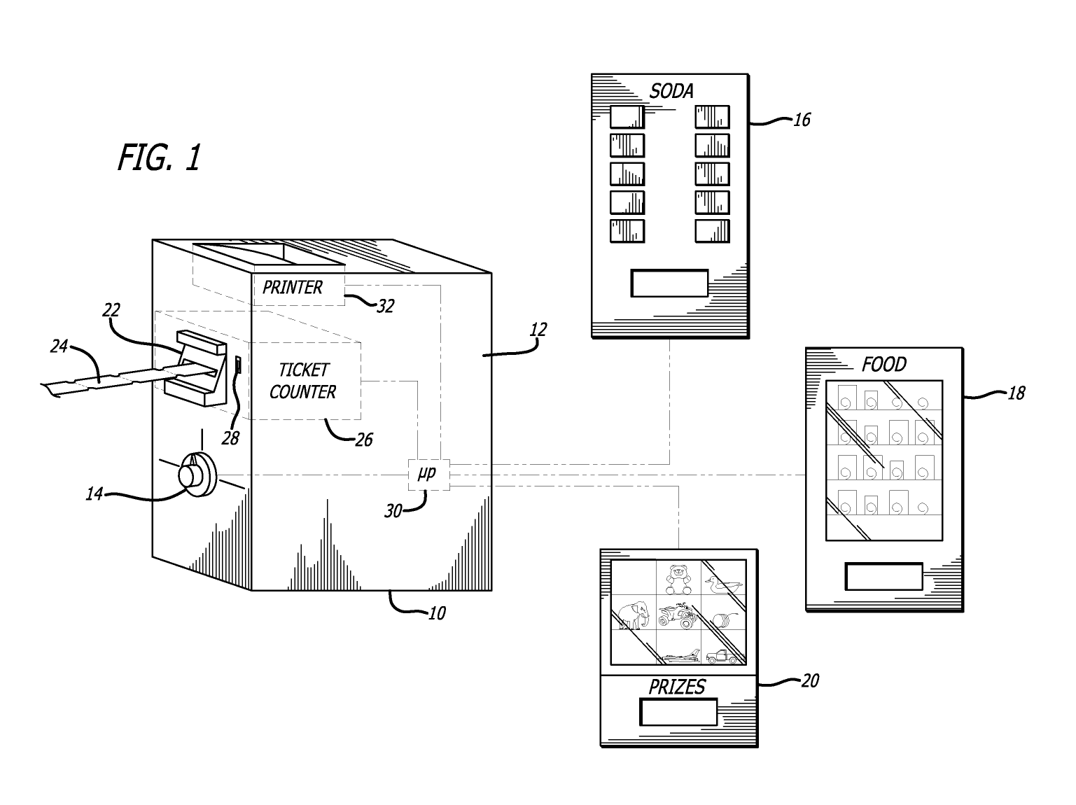

FIG. 1 illustrates a ticket redemption center 10 of the present invention, including a housing 12 that contains the functional elements of the system. The center 10 includes a selector 14, such as a rotary dial, which can be used to designate one of several connected vending machines 16, 18, 20. The center 10 has a port 22 that is used to receive redemption tickets 24, which feeds directly to a ticket counter 26 within the housing 12. The ticket counter 26 counts the tickets and displays the counted tickets on a display 28. In a preferred embodiment, each time the ticket counter counts enough tickets to create a pulse, the counter 26 resets and the display resets accordingly. The ticket counter 26 is connected to a microprocessor 30, which receives a signal from the counter and keeps a tally of the counted tickets 24. When a designated number of tickets have been counted, the microprocessor 30 sends a pulse or signal to one of the vending machines 16,18,20 depending upon the position of the selector 14. Each pulse or signal can constitute a monetary value, such as fifty cents for example. The pulse can be accumulated to make a purchase from the vending machine, depending upon the number of tickets 24 collected. If the number of tickets do not add up to the designated value, the ticket redemption center 10 has a printer that can print a receipt for the remainder tickets, which can then be used next time. The printer 32 prints a receipt, which in a preferred embodiment can be read by a receipt reader (not shown) to automatically supplement a ticket tally.

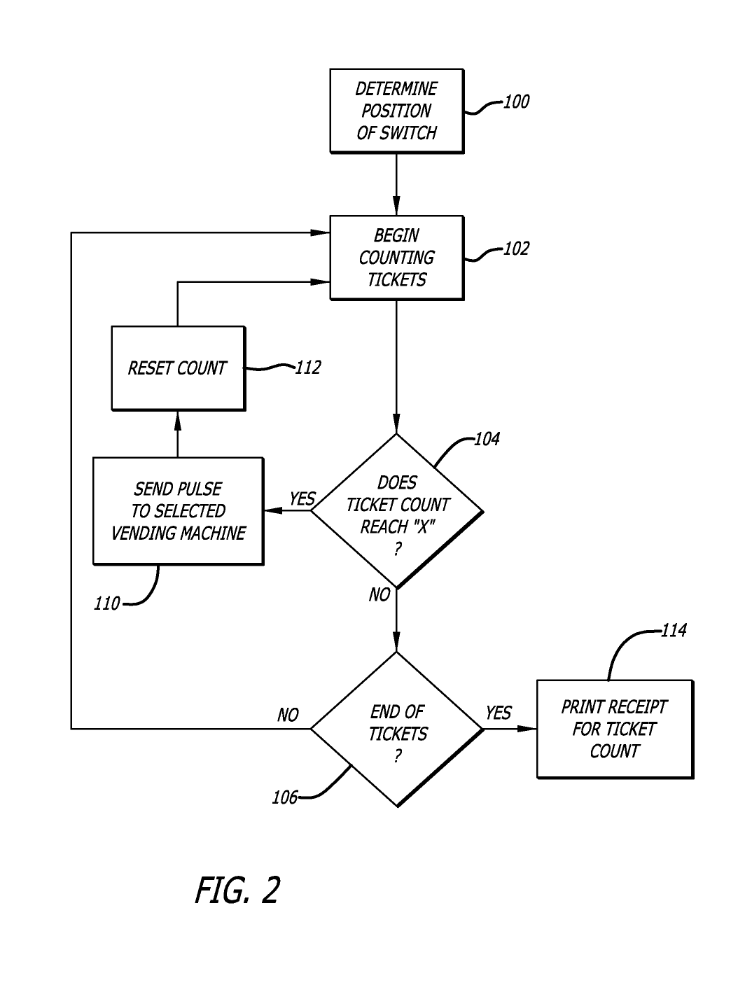

FIG. 2 is a flowchart of the operation of the ticket redemption center. In step 100, the position of the selector 14 is determined to identify which vending machine is to be sent the signal. In step 102, the tickets are fed into the slot 22 and counted by the counter 26. After the ticket is counted, the microprocessor checks in step 104 to see if the tally has reached the designated “pulse” generating value. If yes, it causes the microprocessor to send a pulse in step 110 to the designated vending machine, resets the count in step 112, and continues the counting operation. If not, it checks in step 106 to see if the end of the tickets have been reached. If not, the system continues to count the tickets. Once all the tickets 24 have been counted, the system prints a receipt in step 114 for any remainder tickets which can be used at a future date for purchases.

The system can be modified in a number of ways, and the foregoing description is intended to be merely illustrative and not limiting. For example, the types of vending machines can vary, as can the number of tickets or types of redemption markers. Therefore, no limitation should be interpreted from the foregoing descriptions or drawings, but rather the full scope of the invention should be interpreted from the words of the claims below.

I claim:

1. A system for redemption ticket exchange with connected vending machines, comprising:
a selector designating a chosen vending machine from which to obtain an item;
a ticket counter for receiving tickets and counting the tickets;
a processor for keeping a count of the tickets, and generating a signal when the count reaches a predetermined number;
a pulse generator for sending a pulse to the chosen vending machine when the count reaches a predetermined number, the pulse corresponding to an exchange value that can be used to redeem the item; and
a printer for printing a receipt for tickets that do not total the predetermined number.

2. The system for redemption ticket exchange of claim 1, wherein the vending machines include drink, food, and prize vending machines.

3. The system for redemption ticket exchange of claim 1, wherein the selector is a rotary dial.

4. The system for redemption ticket exchange of claim 1 wherein the ticket counter destroys the tickets once they are counted.
